(19) United States
(12) Patent Application Publication
(10) Pub. No.: US 2010/0012907 A1
(43) Pub. Date: Jan. 21, 2010

(54) LIFTING APPARATUS

(75) Inventor: Yeo (Joseph) B. Lee, Santa Clara, CA (US)

Correspondence Address: MAIER & MAIER, PLLC, 1000 DUKE STREET, ALEXANDRIA, VA, 22314, US

(73) Assignee: K&L Supply Co., Inc., Santa Clara, CA (US)

(21) Appl. No.: 12/486,392

(22) Filed: Jun. 17, 2009

Related U.S. Application Data
(60) Provisional application No. 61/129,796, filed on Jul. 17, 2008.

(51) Int. Cl. B66F 3/25; B66F 3/30

(52) U.S. Cl. 254/131

(57) ABSTRACT

A lifting apparatus may include a base frame, an upper plate and a plurality of support arms engaged with the base frame and the upper plate. The support arms may include first and second support arms adjustably engaged with the upper plate and third and fourth support arms adjustably engaged with the base frame. An exemplary embodiment may also include a power source connected to an engagement member, where the power source can be adapted to manipulate the engagement member and the engagement member can engage the plurality of support arms.

### RELATED APPLICATIONS

This application claims priority, under 35 U.S.C. §119(e), to U.S. Provisional Patent Application Ser. No. 61/129,796, filed Jul. 17, 2008, the disclosure of which is incorporated by reference herein in its entirety.

### BACKGROUND

Hydraulic and/or air lifts, such as automobile lifts, are commonly used to enable a user to work on heavy equipment, such as automobiles, motorcycles, all-terrain vehicles and/or other personal transportation equipment. Some known examples of lifts may be permanently coupled to a floor and generally require a large dedicated space. Such examples may not be practical for individual enthusiasts that desire to work on their own equipment.

Other known examples of lifts merely lift one end of the object and/or only partially lift the object off the ground. Such examples make working on the object very difficult since the user is generally forced to work close to the ground or on their back underneath the object. As a result, a user wishing to work on their personal transportation equipment at a comfortable standing level may be forced to purchase a larger lift than they need and/or dedicate a large portion of the property to house the lift.

### SUMMARY

According to at least one embodiment, a lifting apparatus may include a base frame, an upper plate and a plurality of support arms engaged with the base frame and the upper plate. The support arms may include first and second support arms adjustably engaged with the upper plate and third and fourth support arms adjustably engaged with the base frame. An exemplary embodiment may also include a power source connected to an engagement member, where the power source can be adapted to manipulate the engagement member and the engagement member can engage the plurality of support arms.

In exemplary method of lifting a desired object, the method may include loading an object onto an upper plate supported by a base frame and two pairs of support arms, each pair of support arms connected at a joint. Next, a user can actuate an air control valve in fluid communication with an air cylinder and retract an engagement member connected to the air cylinder, toward the air cylinder. Then a user can raise the upper plate by forcing apart the two pairs of support arms with the engagement member.

### BRIEF DESCRIPTION OF THE FIGURES

Advantages of embodiments of the lifting apparatus will be apparent from the following detailed description of the exemplary embodiments thereof, which description should be considered in conjunction with the accompanying drawings in which:

FIG. 1 is a front perspective view of a first exemplary embodiment of a lifting apparatus.

FIG. 2 is a rear perspective view of a first exemplary embodiment of a lifting apparatus.

FIG. 3 is a cross sectional view of a first exemplary embodiment of an air cylinder.

FIG. 4 is an exploded isometric view of a first exemplary embodiment of a lifting apparatus.

FIG. 5 is an isometric view of a first exemplary embodiment of a lifting apparatus.

FIG. 6 is a front perspective view of a second exemplary embodiment of a lifting apparatus.

FIG. 7 is a rear perspective view of a second exemplary embodiment of a lifting apparatus.

FIG. 8 is a cross sectional view of a second exemplary embodiment of an air cylinder.

FIG. 9 is an exploded isometric view of a second exemplary embodiment of a lifting apparatus.

FIG. 10 is an isometric view of a second exemplary embodiment of a lifting apparatus.

FIG. 11a is an isometric view of a first exemplary embodiment of a locking mechanism in a lowered disengaged position.

FIG. 11b is an isometric view of a first exemplary embodiment of a locking mechanism in a lowered engaged position.

FIG. 11c is an isometric view of a first exemplary embodiment of a locking mechanism in a raised disengaged position.

FIG. 12a is an isometric view of a second exemplary embodiment of a locking mechanism in a lowered disengaged position.

FIG. 12b is an isometric view of a second exemplary embodiment of a locking mechanism in a lowered engaged position.

FIG. 12c is an isometric view of a second exemplary embodiment of a locking mechanism in a raised disengaged position.

### DETAILED DESCRIPTION

Aspects of the lifting apparatus are disclosed in the following description and related drawings directed to specific embodiments of the lifting apparatus. Alternate embodiments may be devised without departing from the spirit or the scope of the lifting apparatus. Additionally, well-known elements of exemplary embodiments of the lifting apparatus will not be described in detail or will be omitted so as not to obscure the relevant details of the lifting apparatus. Further, to facilitate an understanding of the description a discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the lifting apparatus”, “embodiment” or “lifting apparatus” do not require that all embodiments of the lifting apparatus include the discussed feature, advantage or mode of operation.

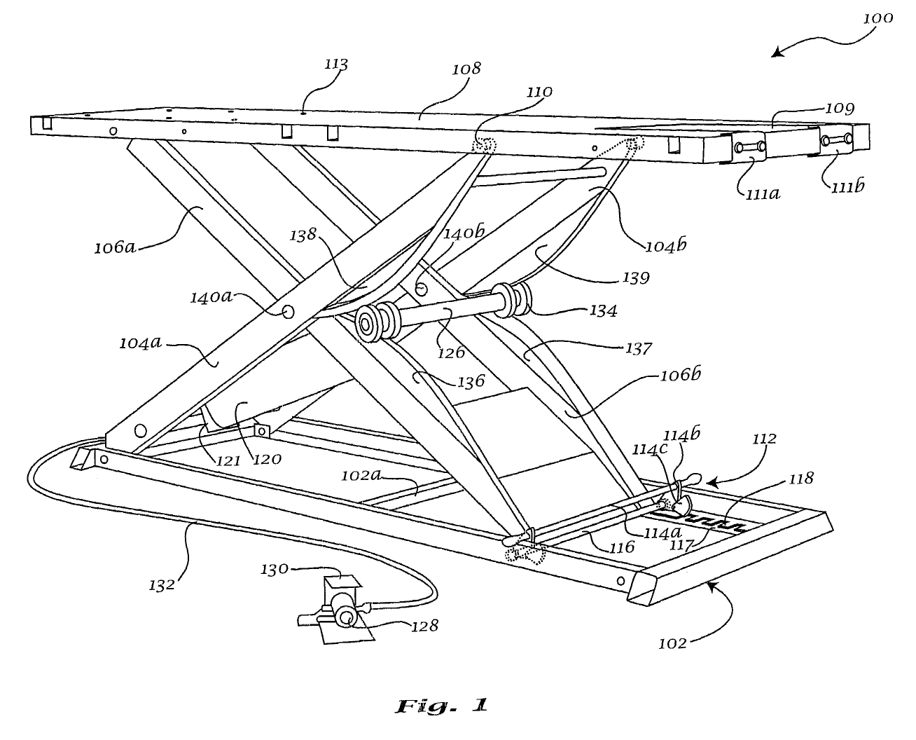

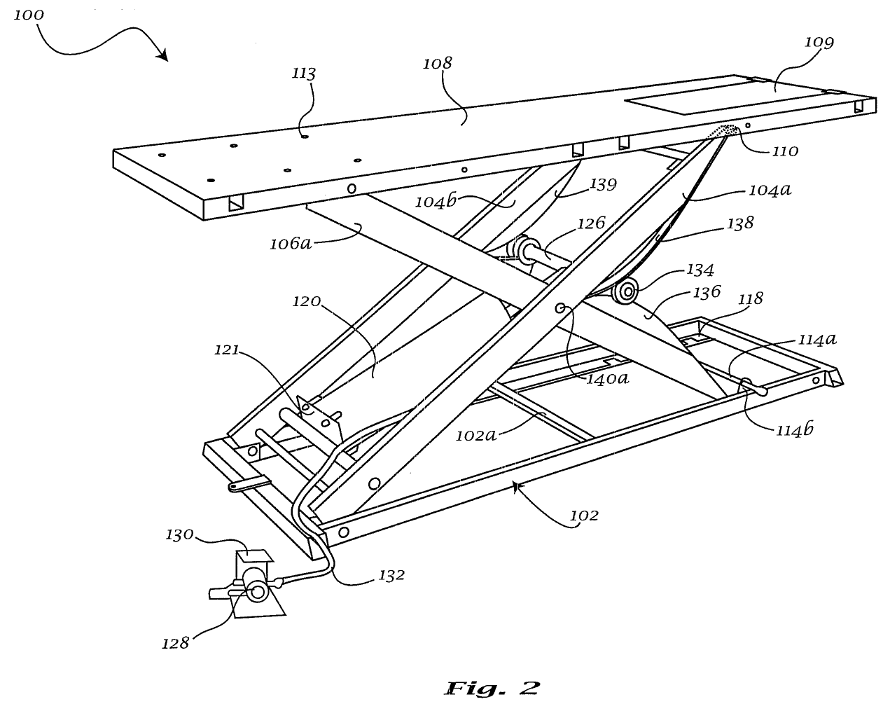

Referring to FIGS. 1-5, in a first exemplary embodiment, lifting apparatus 100 may include a base frame 102. Base frame 102 may be constructed of a steel alloy or any metal alloy known to one having ordinary skill in the art. Base frame 102 may act as the foundation of the lifting apparatus 100 and may be formed in a substantially rectangular shape, having four connected members. The members of base frame 102 may be connected via, welding, bolting, friction fixed or any other method of connecting members known to one skilled in the art. Base frame 102 may also be formed in any other desired shape or configuration, for example, a square shape having four equal length members. Base frame 102 may also include a stability bar 102a, which may be connected to two parallel members of base frame 102. Stability bar 102a, thereby, may provide strength and stability to base frame 102 by helping to prevent deformation or separation by the members of base frame 102.

Lifting apparatus 100 may also include a first support arm 104a and a second support arm 104b. Each support arm 104a and 104b may be connected to base frame 102. The connection between the support arms 104a and 104b and base frame 102 may be a fixed connection that may facilitate pivoting motion of the support arms 104a and 104b, while inhibiting lateral movement of the support arms 104a and 104b with respect to the base frame 102. This connection may include a pivot pin, bolt or any other desired connection means that may be known to one skilled in the art to facilitate pivoting motion and inhibit lateral motion.

Lifting apparatus 100 may also include an upper plate 108 which may be connected to a third support arm 106a and a fourth support arm 106b. Similar to the previously mentioned connection between the support arms 104a and 104b and the base frame 102, the connection between the upper plate 108 and support arms 106a and 106b may be a fixed connection that may facilitate pivoting motion of the support arms 106a and 106b, while inhibiting lateral movement of the support arms 106a and 106b with respect to the upper plate 108. This connection may include a pivot pin, bolt or any other desired connection means that may be known to one skilled in the art to facilitate pivoting motion and inhibit lateral motion.

In the first exemplary embodiment, support arms 104a and 104b may be slidably engaged with the upper plate 108. This slidable connection may be facilitated by rollers 110 fixed to the end of support arms 104a and 104b, on the ends opposite the connection with the base frame 102. Rollers 110 may slide freely in a lateral direction along the underside of the upper plate 108. As the lifting apparatus 100 raises and lowers upper plate 108 the rollers 110 rolling along the underside of the upper plate 108 may facilitate support arms 104a and 104b moving in a lateral direction with respect to the upper plate 108.

Upper plate 108 may also include a drop plate 109 which can be secured in a flush position, as shown in FIGS. 1, 2 and 5, by latches 111a and 111b. Latches 111a and 111b can be slidably adjusted in order to secure drop plate 109 with the upper plate 108 and similarly latches 111a and 111b can be slidably adjusted in order to release drop plate 109, pivoting the drop plate 109 below the upper plate 108 at a hinged connection securing the drop plate 109 to the upper plate 108. The drop plate 109 may be used to provide greater workspace for a user when providing maintenance or alteration to a vehicle, for example, a motorcycle or automobile wheel. Additionally, upper plate 108 may include apertures 113, which may facilitate the attachment of a utility apparatus (not shown), for example a wheel chock or other wheel or vehicle securing apparatus.

The upper plate 108 may also include a ramp 115 which can be attached to the upper plate 108 or the drop plate 109. Upper plate 108 or drop plate 109 may include an elongated aperture 194 defined therein and positioned substantially near an end of upper plate 108 or drop plate 109. In one embodiment, elongated aperture 194 facilitates coupling ramp 115 to upper plate 108 or drop plate 109. Specifically, in the exemplary embodiment, ramp 115 may have a flange 172 coupled thereto and extending substantially away from ramp 115. In one embodiment, flange 172 may be inserted into elongated aperture 194 to facilitate coupling ramp 115 to upper plate 108. The ramp 115 may be used to increase the efficiency by which a vehicle, for example, a motorcycle, all terrain vehicle or automobile, can be loaded onto the upper plate 108 before the lifting apparatus 100 is raised. For example, when the lifting apparatus 100 is in a fully compressed position the ramp 115 can be attached to the upper plate 108 and a vehicle can be pushed up the ramp 115 and onto the upper plate 108. The ramp 115 can then be removed and the lifting apparatus 100 can be raised with the vehicle elevating on top of the upper plate 108.

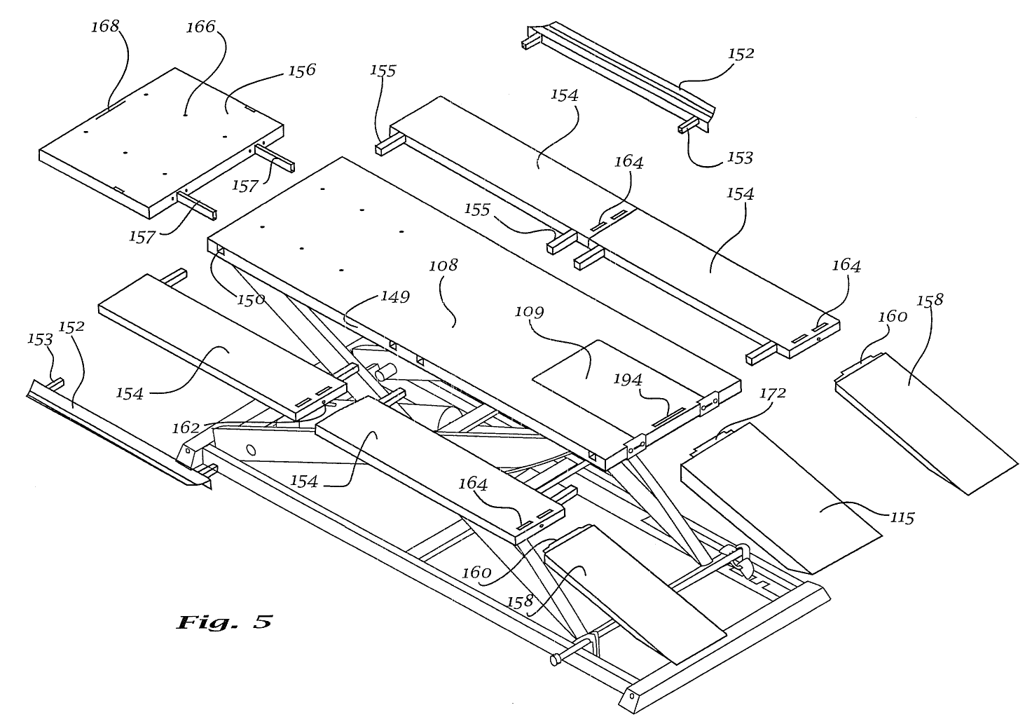

Turning to FIG. 5, upper plate 108 may also include a plurality of attachment apertures 150 defined on the sidewalls 149 of upper plate 108. Attachment apertures 150 may enable the user to couple a variety of attachments to upper plate 108. In one embodiment, attachments may be, but not limited to, a tool holder 152. Tool holder 152 may include inserts 153 to facilitate coupling tool holder 152 to upper plate 108 via attachment apertures 150 in a mortise-and-tenon arrangement. In another embodiment, tool holder 152 may be coupled to upper plate 108 via a tongue-and-groove arrangement, or any other method known to a person having ordinary skill in the art.

In another embodiment, attachments may be, but not limited to, a set of side platform extenders 154 and front platform extender 156 that facilitate expanding the top surface area of upper plate 108 to enable the user to load larger objects thereon. Each of side platform extenders 154 may include inserts 155 to facilitate coupling side platform extenders 154 to upper plate 108 via attachment apertures 150 in a mortise-and-tenon arrangement. In another embodiment, side platform extenders 154 may be coupled to upper plate 108 via a tongue-and-groove arrangement, or any other method known to a person having ordinary skill in the art. Side platform extenders 154 may include apertures 162 defined therein for removably coupling side platform extenders 154 to each other by means of screws, bolts, or other similar methods known in the art. Side platform extenders 154 may also include elongated apertures 164 defined therein and positioned substantially near an end of each side platform extender 154. In one embodiment, elongated apertures 164 facilitate coupling a side ramp 158 to side platform extender 154. Specifically, in the exemplary embodiment, side ramps 158 may have a flange 160 coupled thereto and extending substantially away from each side ramp 168. In one embodiment, flanges 160 may be inserted into elongated apertures 164 to facilitate coupling side ramps 158 to side platform extenders 154.

Front platform extender 156 may include inserts 157 to facilitate coupling front platform extender 156 to upper plate 108 via attachment apertures (not shown) in a mortise-and-tenon arrangement. In another embodiment, front platform extender 156 may be coupled to upper plate 108 via a tongue-and-groove arrangement, or any other method known to a person having ordinary skill in the art. Front platform extender 156 may include apertures 166 defined therein which may facilitate the coupling of a utility apparatus (not shown) thereto. In one embodiment, the utility apparatus may be a wheel chock or other wheel or vehicle securing apparatus. Moreover, front platform extender 156 may include an elongated aperture 168 defined therein and positioned substantially near an end of front platform extender 156. In one embodiment, elongated aperture 268 facilitates coupling ramp 115 to front platform extender 156, as described above.

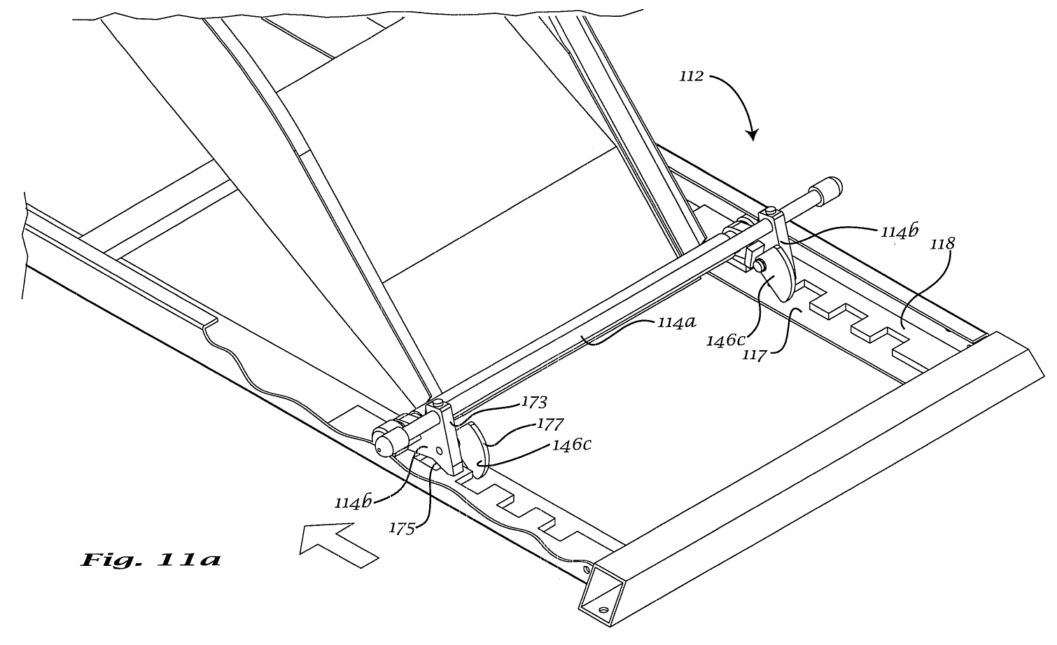

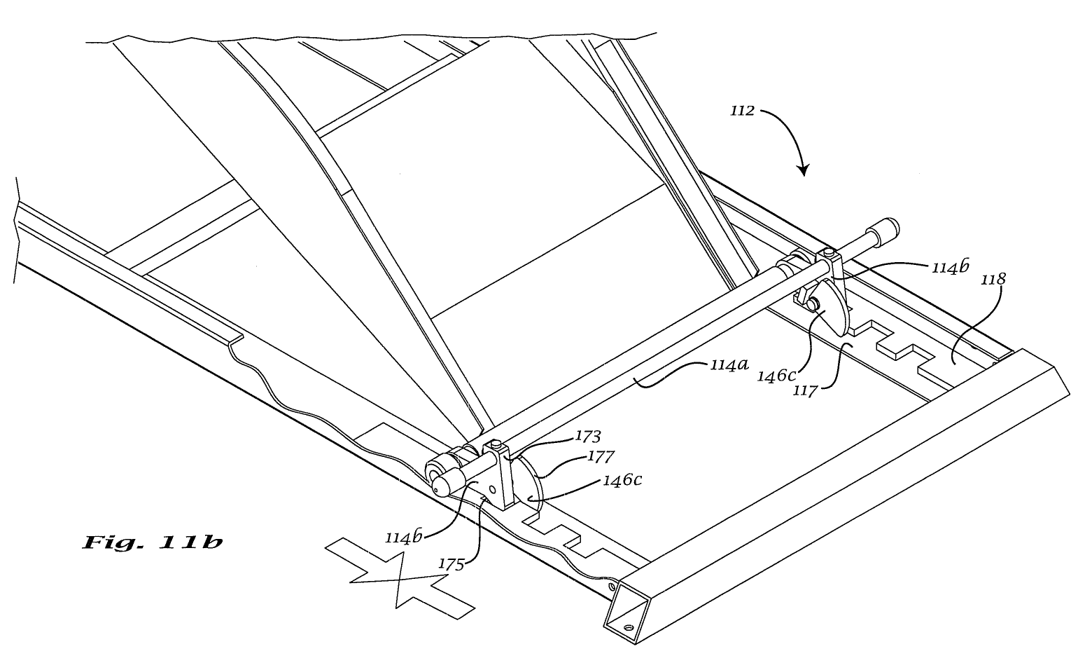

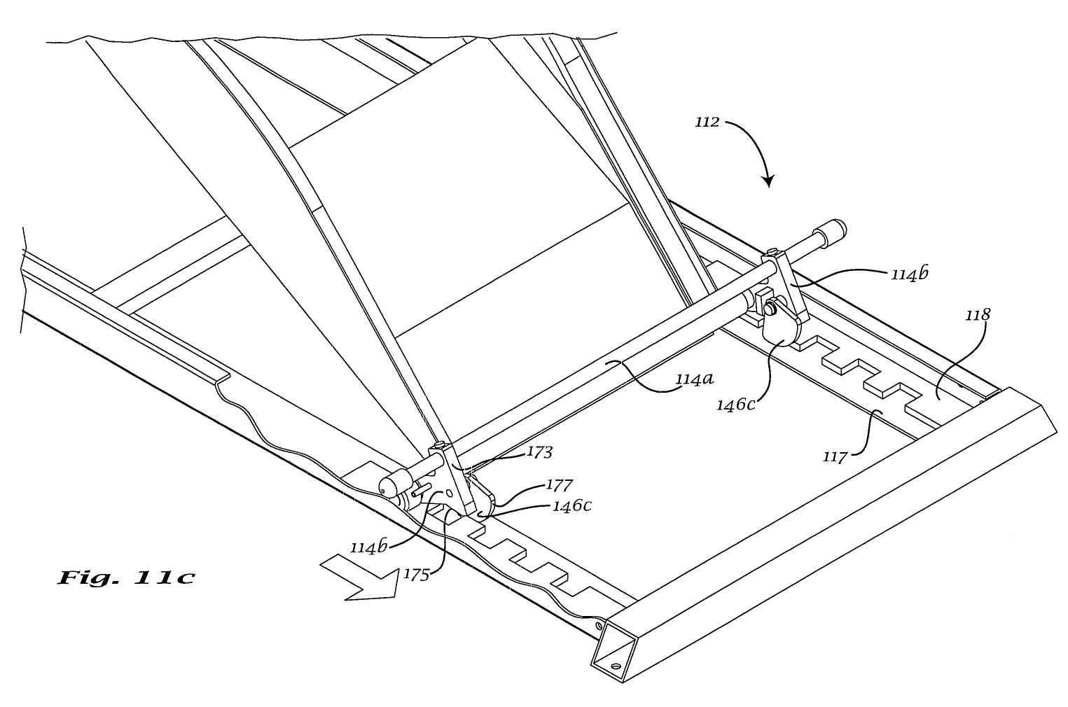

Referring to FIGS. 11a-11c, in the first exemplary embodiment, support arms 106a and 106b may be adjustably engaged with the base plate 102. This adjustable connection may be facilitated by locking assembly 112 which may be fixed to the end of support arms 106a and 106b, on the ends opposite the connection with the upper plate 108. Locking assembly 112 may include a release bar 114a, locking member 114b, and cam member 114c. Release bar 114a may extend between support arms 106a and 106b and may be coupled with two locking members 114b, one locking member 114b coupled to each of the support arms 106a and 106b. Additionally, each locking member 114b may be pivotably attached to a pivot bar 116, which may also be coupled to each of the support arms 106a and 106b. Each locking member 114b may include a bottom face having a section 175 that is substantially angled forward to facilitate sliding locking member 114b over a notched slide 118 during operation and a rear face 173 that is substantially vertical to facilitate engaging locking member 114b with notched slide 118. Cam member 114c may be pivotally attached to each locking member 114b. Each cam member 114c may have a substantially arcuate face 177 to facilitate raising of locking assembly 112 above notched slide 118 by engagement with a base portion 117.

This locking assembly 112 may provide a safety guard as the lifting apparatus 100 raises the upper plate 108 and support arms 106a and 106b slide along the base frame in a lateral direction (shown in FIG. 11a). As the support arms 106a and 106b move in a lateral direction the locking member 114b may engage notched slide 118, and locking member 114b may fit and lock in between the notches, which may prevent support arms 106a and 106b from reversing their lateral motion which would cause a lowering of the upper plate 108 (shown in FIG. 11b).

A user may, for example, adjust the height of the upper plate 108 or collapse the lifting apparatus 100 completely, by lifting the release bar 114a which may in turn disengage the locking member 114b from notched slide 118 (shown in FIG. 11c). As a result, cam members 114c may lower below notched slide 118 such that substantially arcuate face 177 is engaged with base portion 117, thereby elevating locking members 114b above notched slide 118. Consequently, locking assembly 112 is maintained in a raised position and the support arms 106a and 106b may move freely in either lateral direction and can thus be adjusted in order to adjust the desired height of the upper plate 108. After the desired adjustment is made the release bar 114a can be lowered facilitating the locking member 114b again engaging the notched slide 118.

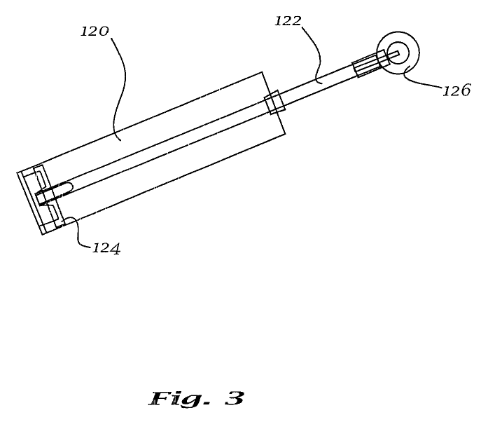

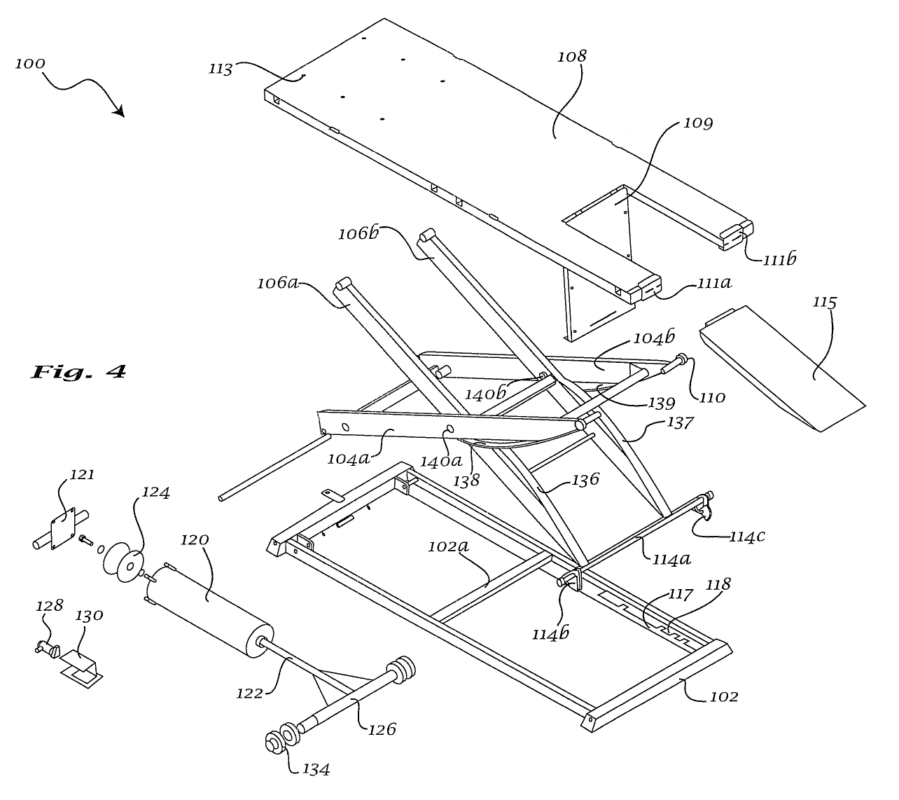

In the first exemplary embodiment, the lifting apparatus 100 may also include an air cylinder 120. As shown in FIGS. 3 and 4, air cylinder 120 may include a cylinder rod 122 which can be connected to a piston 124 within a chamber of the air cylinder 120. The air cylinder 120 can be connected between support arms 104a and 104b through an air cylinder bracket 121. The air cylinder bracket 121 can be attached to a terminal end of the air cylinder 120 and can be anchored between support arms 104a and 104b. Air cylinder 120 can also be anchored to the base frame 102 and can be anchored by any desired connection known to one skilled in the art.

Air pressure within the air cylinder 120 can be controlled through the use of an air control valve 128, which can be controlled or manipulated through the use of a foot bracket assembly 130. The air control valve 128 can be in fluid communication with the fluid within the air cylinder 120 through air hose 132. The air pressure within cylinder 120 can be regulated or manipulated though the use of any desired valve assembly known to one skilled in the art that can facilitate the regulation of air or fluid pressure.

The cylinder rod 122 can be attached to an engagement bar 126, which can facilitate lateral movement of support arms 104a and 104b with respect to the upper plate 108 and facilitate lateral movement of support arms 106a and 106b with respect to the base frame 102. In use, a user may manipulate the air pressure within the air cylinder 120 though the control valve, which can retract the cylinder rod 122 and, thereby, retract the engagement bar 126 toward the air cylinder 120.

Both terminal ends of the engagement bar 126 may include rollers 134 or, for example, a pair of ball bearings separated by a spacer. Each roller 134 can engage a pair of adjacent guide rails 136 and 138, and 137 and 139. The guide rails 136, 137, 138 and 139 may be attached to support arms 106a, 106b, 104a and 104b, respectively. The guide rails 136, 137, 138 and 139 may be have an arcuate shape, for example, each guide rail 136, 137, 138 and 139 may have a decreasing radius of curvature as it approaches the adjustable end of the corresponding support arm 104a, 104b, 106a and 106b. The guide rails 136, 137, 138 and 139 can also, for example, be formed in any desired shape or have any desired radius of curvature.

In use, the cylinder rod 122 can be retracted and, thereby, retract the engagement bar 126 toward the air cylinder 120. As the engagement bar 126 is retracted, rollers 134 can engage rails 136 and 138, and 137 and 139 as the rollers 134 approach pivot joints 140a and 140b, which connect support arms 104a and 106a and 104b and 106b, respectively. As the rollers 134 engage rails 136 and 138, and 137 and 139, the support arms 104a and 104b may be forced apart from support arms 106a and 106b, about pivot joints 140a and 140b respectively. Similarly, if the engagement bar 126 is extended away from air cylinder 120, rollers 134 can recede from pivot joints 140a and 140b, and thereby, support arms 104a and 104b may compress with support arms 106a and 106b, about pivot joints 140a and 140b respectively.

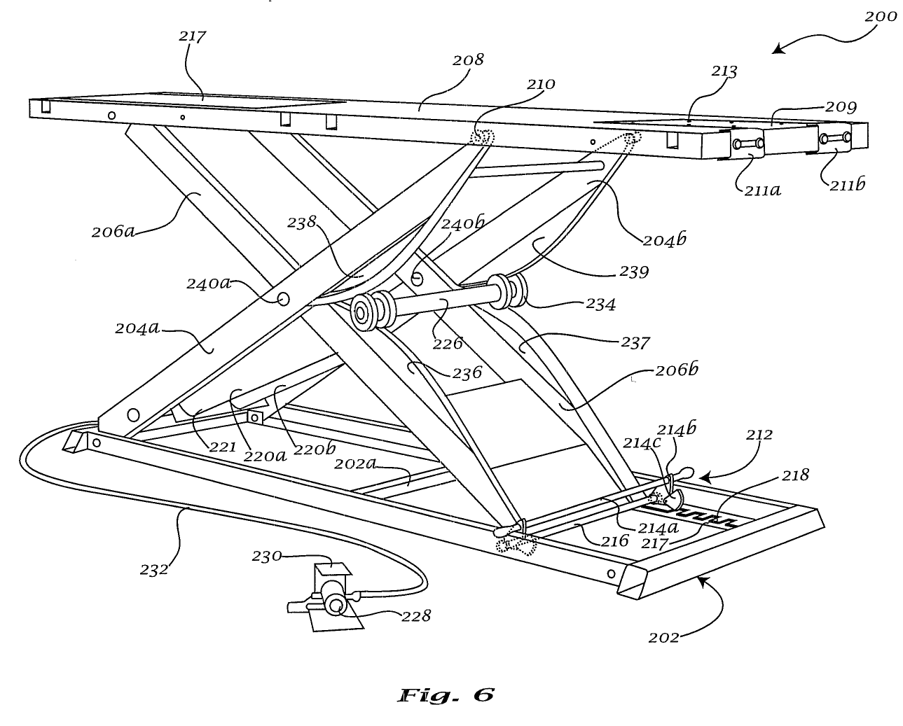

Referring to FIGS. 6-10, in a second exemplary embodiment, lifting apparatus 200 may include a base frame 202. Base frame 202 may be constructed of a steel alloy or any metal alloy known to one having ordinary skill in the art. Base frame 202 may act as the foundation of the lifting apparatus 200 and may be formed in a substantially rectangular shape, having four connected members. Similar to the first exemplary embodiment, the members of base frame 202 may be connected via, welding, bolting, friction fixed or any other method of connecting members known to one skilled in the art. Base frame 202 may also be formed in any other desired shape or configuration, for example, a square shape having four equal length members. Base frame 202 may also include a stability bar 202a, which may be connected to two parallel members of base frame 202. Stability bar 202a, thereby, may provide strength and stability to base frame 202 by helping to prevent deformation or separation by the members of base frame 202.

Lifting apparatus 200 may also include a first support arm 204a and a second support arm 204b. Each support arm 204a and 204b may be connected to base frame 202. The connection between the support arms 204a and 204b and base frame 202 may be a fixed connection that may facilitate pivoting motion of the support arms 204a and 204b, while inhibiting lateral movement of the support arms 204a and 204b with respect to the base frame 202. This connection may include a pivot pin, bolt or any other desired connection means that may be known to one skilled in the art to facilitate pivoting motion and inhibit lateral motion.

Lifting apparatus 200 may also include an upper plate 208 which may be connected to a third support arm 206a and a fourth support arm 206b. Similar to the previously mentioned connection between the support arms 204a and 204b and the base frame 202, the connection between the upper plate 208 and support arms 206a and 206b may be a fixed connection that may facilitate pivoting motion of the support arms 206a and 206b, while inhibiting lateral movement of the support arms 206a and 206b with respect to the upper plate 208. This connection may include a pivot pin, bolt or any other desired connection means that may be known to one skilled in the art to facilitate pivoting motion and inhibit lateral motion.

In the first exemplary embodiment, support arms 204a and 204b may be slidably engaged with the upper plate 208. This slidable connection may be facilitated by rollers 210 fixed to the end of support arms 204a and 204b, on the ends opposite the connection with the base frame 202. Rollers 210 may slide freely in a lateral direction along the underside of the upper plate 208. As the lifting apparatus 200 raises and lowers upper plate 208 the rollers 210 rolling along the underside of the upper plate 208 may facilitate support arms 204a and 204b moving in a lateral direction with respect to the upper plate 208.

Upper plate 208 may also include a drop plate 209 which can be secured in a flush position, as shown in FIGS. 6, 7 and 10, by latches 211a and 211b. Latches 211a and 211b can be slidably adjusted in order to secure drop plate 209 with the upper plate 208 and similarly latches 211a and 211b can be slidably adjusted in order to release drop plate 209, pivoting the drop plate 209 below the upper plate 208 at a hinged connection securing the drop plate 209 to the upper plate 208. The drop plate 209 may be used to provide greater workspace for a user when providing maintenance or alteration to a vehicle, for example, a motorcycle or automobile wheel.

Additionally, upper plate 208 may include a second drop plate 217 which can be positioned at an end off the upper plate 208 opposite drop plate 209. Drop plate 217 may also function in all of the same ways as drop plate 209, having a hinged connection and locking latches. Similarly, drop plate 217 can also provide workspace for a user when providing maintenance or alteration to a vehicle, for example, a motorcycle or automobile wheel, in addition to drop plate 209. Upper plate 208 may also include apertures 213, which may facilitate the attachment of a utility apparatus (not shown), for example a wheel chock or other wheel or vehicle securing apparatus.

The upper plate 208 may also include a ramp 215 which can be attached to the upper plate 208 or the drop plate 209. Upper plate 208 or drop plate 209 may include an elongated aperture 294 defined therein and positioned substantially near an end of upper plate 208 or drop plate 209. In one embodiment, elongated aperture 294 facilitates coupling ramp 215 to upper plate 208 or drop plate 209. Specifically, in the exemplary embodiment, ramp 215 may have a flange 272 coupled thereto and extending substantially away from ramp 215. In one embodiment, flange 272 may be inserted into elongated aperture 294 to facilitate coupling ramps 215 to upper plate 208. The ramp 215 may be used to increase the efficiency by which a vehicle, for example, a motorcycle, all terrain vehicle or automobile, can be loaded onto the upper plate before the lifting apparatus 200 is raised. For example, when the lifting apparatus 200 is in a fully compressed position the ramp 215 can be attached to the upper plate 208 and a vehicle can be pushed up the ramp 215 and onto the upper plate 208. The ramp 215 can then be removed and the lifting apparatus 200 can be raised with the vehicle elevating on top of the upper plate 208.

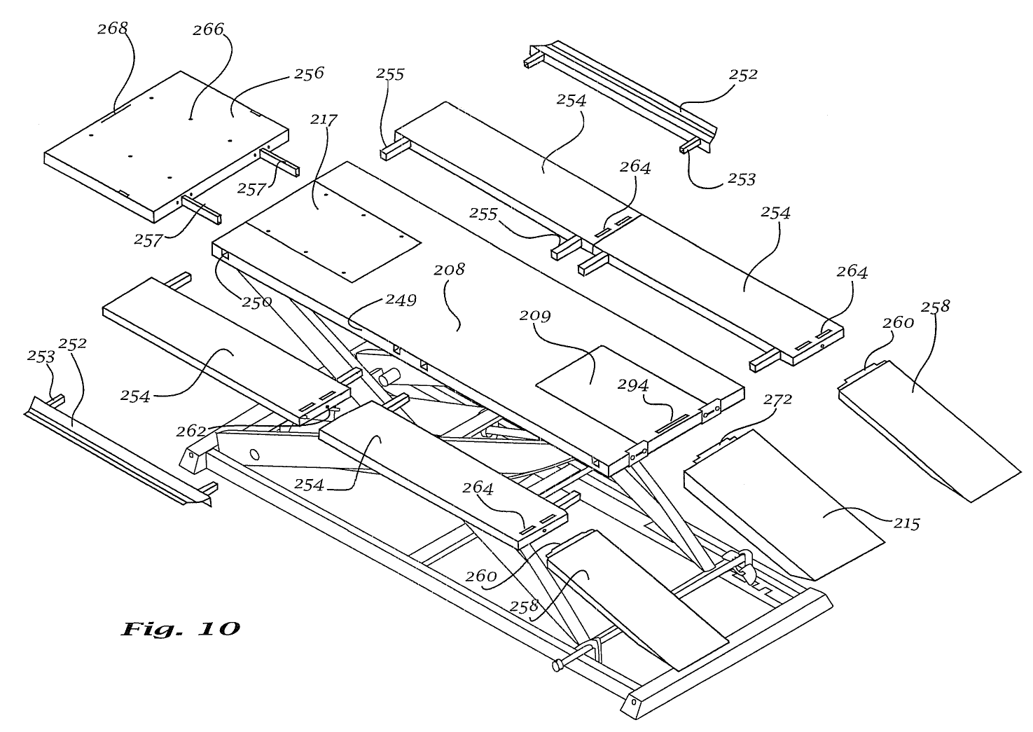

Turning to FIG. 10, upper plate 208 may also include a plurality of attachment apertures 250 defined on the sidewalls 249 of upper plate 208. Attachment apertures 250 may enable the user to couple a variety of attachments to upper plate 208. In one embodiment, attachments may be, but not limited to, a tool holder 252. Tool holder 252 may include inserts 253 to facilitate coupling tool holder 252 to upper plate 208 via attachment apertures 250 in a mortise-and-tenon arrangement. In another embodiment, tool holder 252 may be coupled to upper plate 208 via a tongue-and-groove arrangement, or any other method known to a person having ordinary skill in the art.

In another embodiment, attachments may be, but not limited to, a set of side platform extenders 254 and front or rear platform extender 256 that facilitate expanding the top surface area of upper plate 208 to enable the user to load larger objects thereon. Each of side platform extenders 254 may include inserts 255 to facilitate coupling side platform extenders 254 to upper plate 208 via attachment apertures 250 in a mortise-and-tenon arrangement. In another embodiment, side platform extenders 254 may be coupled to upper plate 208 via a tongue-and-groove arrangement, or any other method known to a person having ordinary skill in the art. Side platform extenders 254 may include apertures 262 defined therein for removably coupling side platform extenders 254 to each other by means of screws, bolts, or other similar methods known in the art. Side platform extenders 254 may also include elongated apertures 264 defined therein and positioned substantially near an end of each side platform extender 254. In one embodiment, elongated apertures 264 facilitate coupling a side ramp 258 to side platform extender 254. Specifically, in the exemplary embodiment, side ramps 258 may have a flange 260 coupled thereto and extending substantially away from each side ramp 268. In one embodiment, flanges 260 may be inserted into elongated apertures 262 to facilitate coupling side ramps 258 to side platform extenders 254.

Front or rear platform extender 256 may include inserts 257 to facilitate coupling front platform extender 256 to upper plate 208 via attachment apertures (not shown) in a mortise-and-tenon arrangement. In another embodiment, front platform extender 256 may be coupled to upper plate 208 via a tongue-and-groove arrangement, or any other method known to a person having ordinary skill in the art. Front platform extender 256 may include apertures 266 defined therein which may facilitate the coupling of a utility apparatus (not shown) thereto. In one embodiment, the utility apparatus may be a wheel chock or other wheel or vehicle securing apparatus. Moreover, front platform extender 256 may include an elongated aperture 268 defined therein and positioned substantially near an end of front platform extender 256. In one embodiment, elongated aperture 268 facilitates coupling ramp 215 to front platform extender 256, as described above.

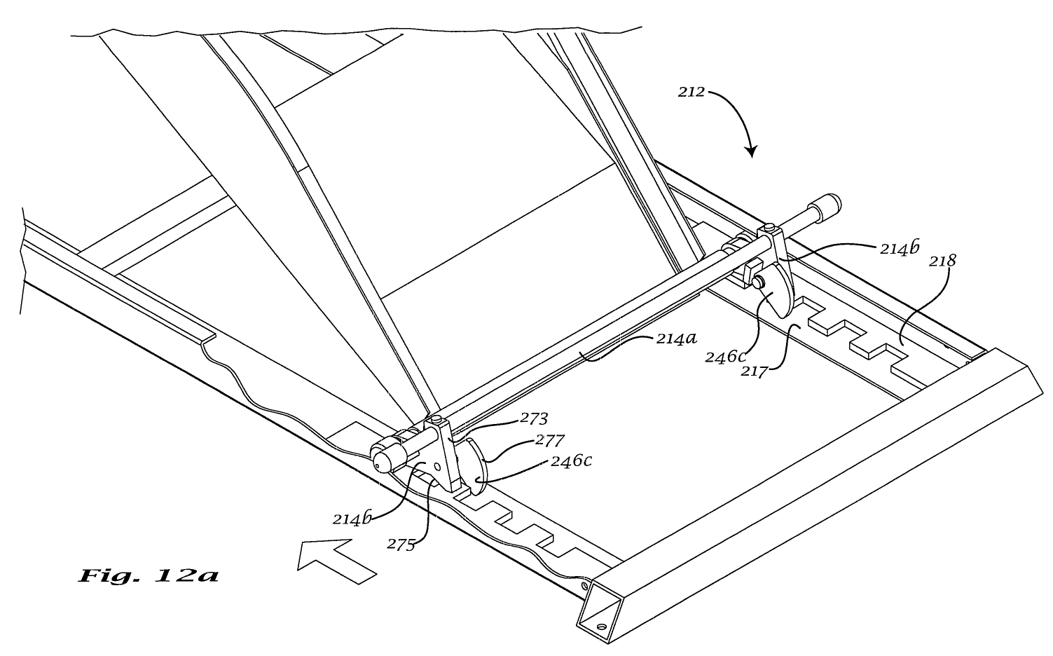

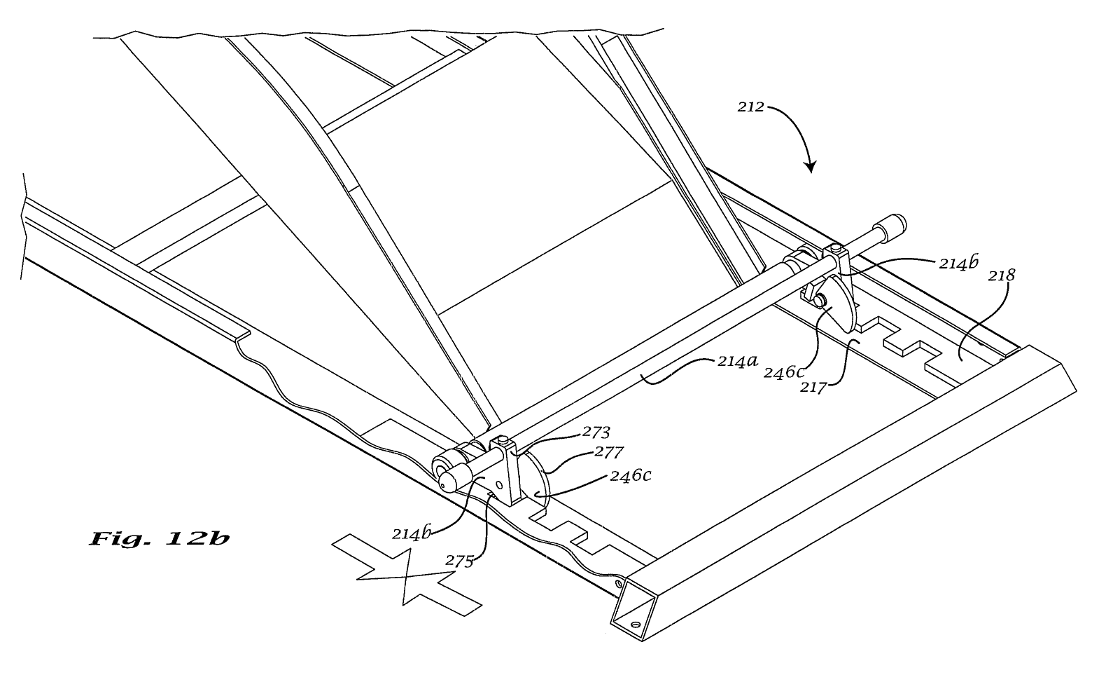

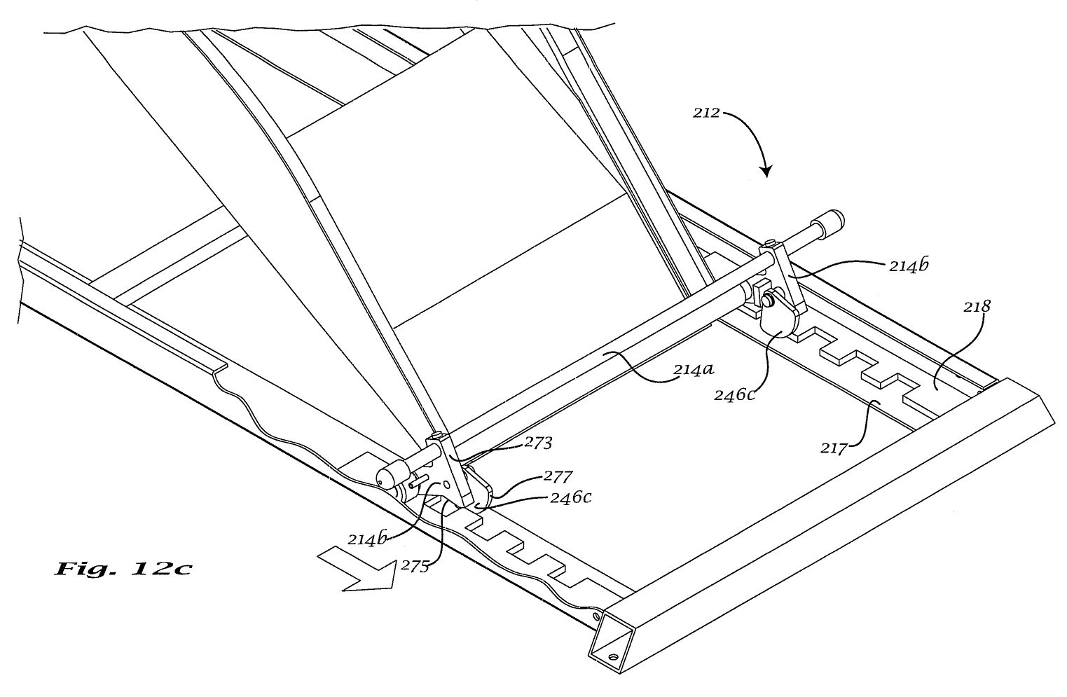

Referring to FIGS. 12a-12c, in the second exemplary embodiment, support arms 206a and 206b may be adjustably engaged with the base plate 202. This adjustable connection may be facilitated by locking assembly 212 which may be fixed to the end of support arms 206a and 206b, on the ends opposite the connection with the upper plate 208. Locking assembly 212 may include a release bar 214a, locking member 214b and cam member 214c. Release bar 214a may extend between support arms 206a and 206b and may be coupled with two locking members 214b, one locking member 214b coupled to each of the support arms 206a and 206b. Additionally, each locking member 214b may be pivotably attached to a pivot bar 216, which may also be coupled to each of the support arms 206a and 206b. Each locking member 214b may include a bottom face having a section 275 that is substantially angled forward to facilitate sliding locking member 214b over a notched slide 218 during operation and a rear face 273 that is substantially vertical to facilitate engaging locking member 214b with notched slide 218. Cam member 214c may be pivotally attached to each locking member 214b. Each cam member 214c may have a substantially arcuate face 277 to facilitate raising of locking assembly 212 above notched slide 218 by engagement with a base portion 217.

This locking assembly 212 may provide a safety guard as the lifting apparatus 200 raises the upper plate 208 and support arms 206a and 206b slide along the base frame in a lateral direction (shown in FIG. 12a). As the support arms 206a and 206b move in a lateral direction the locking member 214b may engage a notched slide 218, and locking member 214b may fit and lock in between the notches, which may prevent support arms 206a and 206b from reversing their lateral motion which can cause a lowering of the upper plate 208 (shown in FIG. 12b).

A user may, for example, adjust the height of the upper plate 208 or collapse the lifting apparatus 200 completely, by lifting the release bar 214a which may in turn disengage the locking member 214b from the notched slide 218 (shown in FIG. 12c). As a result, cam members 214c may lower below notched slide 218 such that substantially arcuate face 277 is engaged with base portion 217, thereby elevating locking members 114b above notched slide 118. Consequently, locking assembly 112 is maintained in a raised position and support arms 206a and 206b may move freely in either lateral direction and can thus be adjusted in order to adjust the desired height of the upper plate 208. After the desired adjustment is made the release bar 214a can be lowered facilitating the locking member 214b again engaging the notched slide 218.

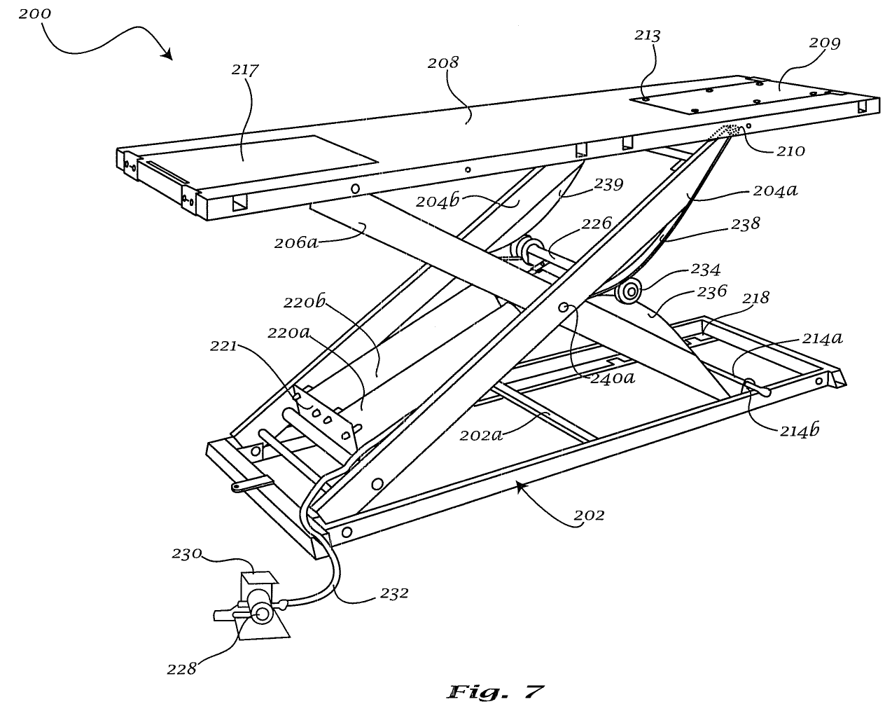

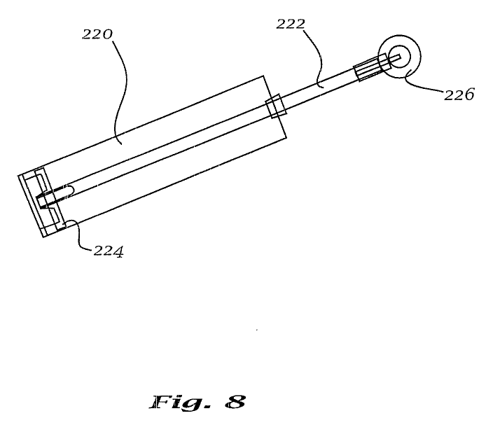

In the second exemplary embodiment, the lifting apparatus 200 may also include air cylinders 220a and 220b. Air cylinders 220a and 220b may have the same specifications and design or they may vary in size and/or output capability. As shown in FIGS. 7 and 8, air cylinder 220a may include a cylinder rod 222a which can be connected to a piston 224 within a chamber of the air cylinder 220a. Air cylinders 220a and 220b can be connected between support arms 204a and 204b through an air cylinder bracket 221. The air cylinder bracket can be attached to a terminal end of both air cylinder 220a and 220b and be anchored between support arms 204a and 204b. Air cylinders 220a and 220b can also be anchored to the base frame 202 and can be anchored by any desired connection known to one skilled in the art.

Air pressure within the air cylinders 220a and 220b can be controlled through the use of an air control valve 228, which can me controlled or manipulated through the use of a foot bracket assembly 230. The air control valve 228 can be in fluid communication with the fluid within both air cylinder 220a and 220b through air hose 232. The air pressure within air cylinders 220a and 220b can be regulated or manipulated though the use of any desired valve assembly known to one skilled in the art that can facilitate the regulation of air or fluid pressure.

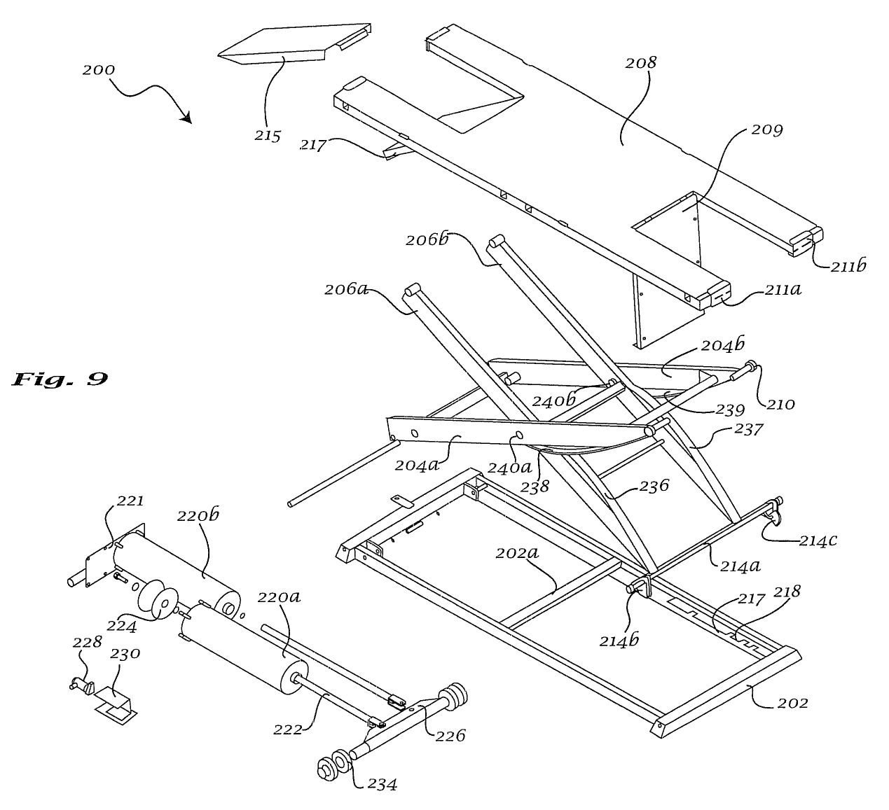

As shown in FIG. 9, cylinder rods 222a and 222b can be attached to an engagement bar 226, which can facilitate lateral movement of support arms 204a and 204b with respect to the upper plate 208 and facilitate lateral movement of support arms 206a and 206b with respect to the base frame 202. In use, a user may manipulate the air pressure within the air cylinder 220 though the control valve 228, which can retract air cylinder rods 222a and 222b and, thereby, retract the engagement bar 226 toward air cylinders 220a and 220b. Having dual air cylinders 220a and 220b, as opposed to the first exemplary embodiment having only one air cylinder 220, can provide additional lifting capability to the lifting apparatus 200, thereby enabling the lifting apparatus 200 to support and lift vehicles or other desired objects have heavier weights than lifting apparatus 100 may be capable of supporting and lifting.

In the second exemplary embodiment, both terminal ends of the engagement bar 226 may include rollers 234 or, for example, a pair of ball bearings separated by a spacer. Each roller 234 can engage a pair of adjacent guide rails 236 and 238, and 237 and 239. The guide rails 236, 237, 238 and 239 may be attached to support arms 206a, 206b, 204a and 204b, respectively. The guide rails 236, 237, 238 and 239 may be have an arcuate shape, for example, each guide rail 236, 237, 238 and 239 may have a decreasing radius of curvature as it approaches the adjustable end of the corresponding support arm 204a, 204b, 206a and 206b. The guide rails 236, 237, 238 and 239 can also, for example, be formed in any desired shape or have any desired radius of curvature.

In use, the cylinder rods 222a and 222b can be retracted and, thereby, retract the engagement bar 226 toward the air cylinders 220a and 220b. As the engagement bar 226 is retracted, rollers 234 can engage rails 236 and 238, and 237 and 239 as the rollers 234 approach pivot joints 240a and 240b, which connect support arms 204a and 206a and 204b and 206b, respectively. As the rollers 234 engage rails 236 and 238, and 237 and 239, the support arms 204a and 204b may be forced apart from support arms 206a and 206b, about pivot joints 240a and 240b respectively. Similarly, if the engagement bar 226 is extended away from air cylinder 220, rollers 234 can recede from pivot joints 240a and 240b, and thereby, support arms 204a and 204b may compress with support arms 206a and 206b, about pivot joints 240a and 240b respectively.

The foregoing description and accompanying drawings illustrate the principles, preferred embodiments and modes of operation of the lifting apparatus. However, the lifting apparatus should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the lifting apparatus as defined by the following claims.

What is claimed is:

1. A lifting apparatus comprising:
a base frame;
an upper plate;
a plurality of support arms engaged with the base frame and the upper plate, wherein the support arms include first and second support arms adjustably engaged with the upper plate and third and fourth support arms adjustably engaged with the base frame; and
a power source connected to an engagement member, wherein the power source is adapted to manipulate the engagement member and the engagement member is engaged with the plurality of support arms.

2. The lifting apparatus of claim 1, wherein the plurality of support arms include guide members engaged with the engagement member.

3. The lifting apparatus of claim 2, wherein the guide members have an arcuate shape.

4. The lifting apparatus of claim 3, wherein the guide members have a variable radius of curvature.

5. The lifting apparatus of claim 1, wherein the power source is an air cylinder.

6. The lifting apparatus of claim 1, wherein the power source includes a plurality of air cylinders.

7. The lifting apparatus of claim 1, further comprising:
a drop plate connected to the upper plate via a hinge.

8. The lifting apparatus of claim 7, wherein the drop plate is releasably secured in a flush position with upper plate via at least one latch.

9. The lifting apparatus of claim 1, further comprising:
a locking assembly fixed to the third and fourth support arms, wherein the locking assembly releasably locks the third and fourth support arms against lateral movement with respect to the base frame.

10. The lifting apparatus of claim 9, wherein the locking assembly includes a notch slide and a locking member, wherein the locking member mates with a notch of the notch slide when the locking assembly is in a locking position.

11. The lifting apparatus of claim 10, wherein the locking assembly includes a release bar which releasably adjusts the locking position of the locking assembly.

12. The lifting apparatus of claim 11, wherein the locking assembly includes a cam member rotatably coupled to the locking member, which facilitates raising the locking assembly above the notch slide.

13. The lifting apparatus of claim 1, wherein the engagement member retains constant contact with the first, second, third and fourth support members throughout use of the lifting apparatus.

14. The lifting apparatus of claim 2, wherein the engagement member includes a plurality of rollers, wherein the rollers facilitate rolling engagement of the engagement member with the guide members.

15. The lifting apparatus of claim 5 further comprising:
an air control valve; and
an air tube connecting the air control valve with the air cylinder, wherein the air control valve manipulates air pressure within the air cylinder.

16. The lifting apparatus of claim 1, wherein the first and second support arms each include a roller which facilitates the adjustable engagement of the first and second support arms with the upper plate, and
wherein the first and second support arms are fixed to the base frame.

17. The lifting apparatus of claim 1 further comprising:
at least one platform extender removably coupled to said platform.

18. The lifting apparatus of claim 17 further comprising:
a plurality of attachment apertures defined in at least one side wall of said platform, wherein said platform extender is removably coupled to said platform via said attachment apertures.

19. The lifting apparatus of claim aim 17 further comprising:
at least one ramp removably coupled to said at least one platform extender.

20. A method of elevating an object comprising:
loading an object onto an upper plate supported by a base frame and two pairs of support arms, each pair of support arms connected at a joint;
actuating an air control valve in fluid communication with an air cylinder;
retracting an engagement member connected to the air cylinder, toward the air cylinder; and
raising the upper plate by forcing apart the two pairs of support arms with the engagement member.

21. The method of claim 20, wherein the loading of the object includes attaching a ramp to the upper plate and rolling the object up the ramp and onto the upper plate.

22. The method of claim 20, further comprising:
locking the support arms against lateral movement with respect to the base frame, wherein the locking includes engaging a locking member fixed to a pair of the support arms with a notch on a notch slide.

23. The method of claim 22, further comprising:
lowering the upper plate, wherein the lowering includes raising a release bar connected to the locking member, which disengages the locking member from the notch on the notch slide.

24. The method of claim 23, wherein the lowering the upper plate includes lowering a cam member rotatably coupled to the locking member, which raises the locking assembly above the notch slide.

25. The method of claim 20, further comprising:
releasing a drop plate connected to the upper plate, wherein the released drop plate provides a user with increased access to the object.

26. The method of claim 20, further comprising:
coupling at least one platform extender to the platform;
coupling a ramp to the platform extender; and
rolling the object onto the platform using the ramp.
